(19) United States
(12) Patent Application Publication
(10) Pub. No.: US 2024/0019337 A1
(43) Pub. Date: Jan. 18, 2024

(54) METHOD FOR CALCULATING FLEXURAL CAPACITY OF STEEL PLATE-REINFORCED JOINTS IN SHIELD TUNNELS

(71) Applicants: TONGJI UNIVERSITY, Shanghai (CN); Shanghai Tongyan Civil Engineering Technology Corp.,Ltd., Shanghai (CN)

(72) Inventors: Xuezeng LIU, Shanghai (CN); Zhen LI, Shanghai (CN); Zhilu YANG, Shanghai (CN); Xueliang YANG, Shanghai (CN)

(21) Appl. No.: 18/473,872

(22) Filed: Sep. 25, 2023

(30) Foreign Application Priority Data
Sep. 28, 2022 (CN) 202211188057.X

(51) Int. Cl. G01M 5/00; G06F 17/17

(52) U.S. Cl. CPC G01M 5/0041; G06F 17/17

(57) ABSTRACT

A method for calculating flexural capacity of a steel plate-reinforced joint in shield tunnel includes: (S1) obtaining a construction parameter, a material parameter, and a mechanical parameter of a joint surface; and calculating a virtual strain ε_{sp,0}a height x_{cb1} of a critical compression zone for bolt yielding in case of section failure, and a height x_{cb1} of a critical compression zone for steel plate yielding; (S2) calculating a height x_{c} of a compression zone of a joint surface of the steel plate-reinforced joint in a certain failure state; (S3) determining whether x_{c} satisfies a range requirement: if so, executing step (S4); and if no, replacing a new failure state; and skipping to step (S2) until traversing all failure states; and (S4) substituting x_{c} into a bending moment equilibrium equation for the current failure state; and calculating an ultimate bending moment. A computer-readable storage medium is further provided.

### CROSS-REFERENCE TO RELATED APPLICATIONS

This application claims the benefit of priority from Chinese Patent Application No. 202211188057.X, filed on Sep. 28, 2022. The content of the aforementioned application, including any intervening amendments thereto, is incorporated herein by reference in its entirety.

### TECHNICAL FIELD

This application relates to structural reinforcement engineering for shield tunnel, particularly to a structural flexural capacity calculation, and more particularly to a method for calculating flexural capacity of steel plate-reinforced joints in shield tunnels.

### BACKGROUND

In recent years, with the continuous and rapid development of urban shield tunnel projects, the safety performance of segment lining for the shield tunnel has become increasingly serious. The segment lining structure is a prefabricated concrete structure consisting of multiple sets of segments and bolts connected by the multiloop staggered joints, and widely used in the urban underground shield tunnel engineering. During the construction and operation of tunnel shields, the segment lining structure is mainly subjected to external earth pressure, groundwater pressure, ground overloading and dynamic excavation conditions. Therefore, as the external structural support system of the tunnels, the mechanical load-bearing performance and damage mode of the segment lining structure under the external confining pressure are crucial to the safety of the tunnels. Therefore, the effective repair and reinforcement measures must be taken to ensure the operation safety and durability of subway tunnels for the damaged shield tunnel segment rings.

At present, for the shield tunnels with excessive lateral deformation, the internal-tension steel plates are often used to reinforce for preventing deterioration of the damaged lining structure. In the structural reinforcement of shield tunnels, the numerical simulation is often used to analyze the flexural capacity of steel plate-reinforced joints, which needs to establish the three-dimensional simulation model in advance, has a large amount of workload, and cannot quickly determine the flexural capacity of the steel plate-reinforced joints.

### SUMMARY

The object of this application is to provide a method for calculating flexural capacity of steel plate-reinforced joints in shield tunnels, to overcome the inefficiency of existing numerical simulations.

Technical solutions of this application are described as follows.

In a first aspect, this application provides a method for calculating flexural capacity of steel plate-reinforced joints in shield tunnels, including:
(S1) obtaining a construction parameter, a material parameter, and a mechanical parameter of a joint surface; and calculating a virtual strain ε_{sp,0} at an inner edge of the joint surface when a steel plate is reinforced, a height x_{cb1} of a critical compression zone for bolt yielding in case of section failure, and a height x_{cb2} of a critical compression zone for steel plate yielding in case of section failure;
(S2) based on step (S1), assuming that the joint surface is in a certain failure state, and based on an axial force equilibrium equation in the certain failure state, calculating a height x_{c} of a compression zone of the joint surface of the steel plate-reinforced joint;

(S3) determining whether the height x_{c} satisfies a range requirement for the height x_{c} in the certain failure state:

if so, executing step (S4); and

if no, replacing a new failure state; and skipping to step (S2) until traversing all failure states; and

(S4) substituting the height x_{c} into a bending moment equilibrium equation for a current failure state; and calculating an ultimate bending moment.

In an embodiment, the construction parameter comprises a distance from a bolt to an outer edge of the joint surface, a height of the joint surface, a width of the joint surface, a height of the outer edge of the joint surface, a height of an outer edge compression zone, a height of a waterproof zone, a height of a core compression zone, a height of an inner edge of the joint surface, a bolt cross-sectional area, and a steel plate cross-sectional area;

the material parameter comprises a design value of a concrete axial compressive strength, a concrete yield strain, a concrete ultimate compressive strain, a bolt yield strain, a steel plate yield strain, a bolt yield stress, a steel plate yield stress, a bolt elasticity modulus, and a steel plate elasticity modulus; and

the mechanical parameter comprises an axial force and a bending moment of the joint surface when the steel plate is reinforced.

In an embodiment, a formula for calculating the virtual strain ε_{sp,0} at the inner edge of the joint surface when the steel plate is reinforced is expressed as:

$${ε}_{sp , 0} = \frac{{ε}_{c , 0} h}{{x}_{0}} - {ε}_{c , 0} ;$$

wherein ε_{c,0} is a concrete compressive strain at an outer edge of the joint surface when the steel plate is reinforced; x₀ is a height of a compression zone of the joint surface when the steel plate is reinforced; and h is a height of the joint surface;

formulas for calculating ε_{c,0} and x₀ are expressed as:

$${σ}_{c} ( {ε}_{c} ) = {f}_{c} [ 1 - {( 1 - \frac{{ε}_{c}}{{ε}_{c 0}} )}^{2} ] ;$$

$${N}_{0} = b {\int }_{0}^{{x}_{0} - {d}_{1} - {d}_{2} - {d}_{3}} {σ}_{c} ( \frac{p}{{x}_{0}} \cdot {ε}_{c , 0} ) dp + b {\int }_{{x}_{0} - {d}_{1} - {d}_{2}}^{{x}_{0} - {d}_{1}} b {σ}_{c} ( \frac{p}{{x}_{0}} \cdot {ε}_{c , 0} ) dp - {σ}_{m , 0} {A}_{m} ;$$

$${σ}_{m , 0} = \frac{{ε}_{c , 0} ( d - {x}_{0} ) {E}_{m}}{{x}_{0}} ; and$$

$${M}_{0} = b {\int }_{0}^{{x}_{0} - {d}_{1} - {d}_{2} - {d}_{3}} {σ}_{c} ( \frac{p}{{x}_{0}} \cdot {ε}_{c , 0} ) ( h - {x}_{0} + p ) dp + b {\int }_{{x}_{0} - {d}_{1} - {d}_{2}}^{{x}_{0} - {d}_{1}} {σ}_{c} ( \frac{p}{{x}_{0}} \cdot {ε}_{c , 0} ) ( h - {x}_{0} + p ) dp - {σ}_{m , 0} {A}_{m} ( h - d ) - {N}_{0} \cdot \frac{h}{2} ;$$

where σ_{c} is a concrete stress; ε_{c} is a concrete strain; f_{c} is a design value of a concrete axial compressive strength; ε_{c0} is a concrete yield strain; b is a width of the joint surface; d₁ is an outer edge of the joint surface; d₂ is a height of an outer edge compression zone; d₃ is a height of a waterproof zone; d₄ is a height of a core compression zone; d₅ is a height of an inner edge of the joint surface; p is an integral variable; No is an axial force of the joint surface when the steel plate is reinforced; M₀ is a bending moment of the joint surface when the steel plate is reinforced; σ_{m,0} is a bolt stress when the steel plate is reinforced; Aₘ is a bolt cross-sectional area; and Eₘ is a bolt elasticity modulus.

In an embodiment, the height x_{cb1} of the critical compression zone of the bolt yielding and the height x_{cb2} of the critical compression zones of the steel plate yielding are obtained according to the following formulas:

$${x}_{cb 1} = \frac{{ε}_{cu} d}{{ε}_{cu} + {f}_{my} / {E}_{m}} ; and$$

$${x}_{cb 2} = \frac{{ε}_{cu} h}{{ε}_{cu} + {ε}_{sp , 0} + {f}_{spy} / {E}_{sp}} ;$$

wherein ε_{cu} is a concrete ultimate compressive strain; f_{my} is a bolt yield stress; Eₘ is a bolt elasticity modulus; d is a distance from a bolt to an outer edge of the joint surface; f_{spy} is a steel plate yield stress; Eₛₚ is a steel plate elasticity modulus; and h is a height of the joint surface.

In an embodiment, the failure state comprises a failure state S-a, a failure state S-b, a failure state S-c, and a failure state S-d; the failure state S-a refers to a state of bolt yielding and steel plate not-yielding; the failure state S-b refers to a state of both bolt and steel plate yielding; the failure state S-c refers to a state of bolt not yielding and steel plate yielding; and the failure state S-d refers to a state of both bolt and steel plate not yielding;

axial force equilibrium equations in the failure state are expressed as:

the failure state S-a:

$${N}_{1} = b {\sum }_{i = 1}^{n} {\int }_{{d}_{i}}^{{d}_{i + 1}} {σ}_{c} ( \frac{p}{{x}_{c 1}} \cdot {ε}_{cu} ) dp - {f}_{my} {A}_{m} - {σ}_{sp} {A}_{sp} ;$$

the failure state S-b:

$${N}_{2} = b {\sum }_{i = 1}^{n} {\int }_{{d}_{i}}^{{d}_{i + 1}} {σ}_{c} ( \frac{p}{{x}_{c 2}} \cdot {ε}_{cu} ) dp - {f}_{my} {A}_{m} - {f}_{spy} {A}_{sp} ;$$

the failure state S-c:

$${N}_{3} = b {\sum }_{i = 1}^{n} {\int }_{{d}_{i}}^{{d}_{i + 1}} {σ}_{c} ( \frac{p}{{x}_{c 3}} \cdot {ε}_{cu} ) dp - {σ}_{m} {A}_{m} - {f}_{spy} {A}_{sp} ;$$

and

the failure state S-d:

$${N}_{4} = b {\sum }_{i = 1}^{n} {\int }_{{d}_{i}}^{{d}_{i + 1}} {σ}_{c} ( \frac{p}{{x}_{c 4}} \cdot {ε}_{cu} ) dp - {σ}_{m} {A}_{m} - {σ}_{sp} {A}_{sp} ;$$

where σₛₚ is a steel plate stress at section failure; εₛₚ is a steel plate strain at section failure; σₘ is a bolt stress at section failure; b is a width of the joint surface; p is an integral variable; σ_{c} is a concrete stress; ε_{cu} is a concrete ultimate compressive strain; Aₘ is a bolt cross-sectional area; Aₛₚ is a steel plate cross-section area; f_{my} is a bolt yield stress; f_{spy} is a steel plate yield stress; Nᵢ is a section axial force corresponding to each failure state; x_{ci} is a height of a compression zone of the joint surface corresponding to each failure state, i=1 ,2 ,3 ,4; d₁ is a height of an outer edge of the joint surface; d₂ is a height of an outer edge compression zone; d₃ is a height of a waterproof zone; d₄ is a height of a core compression zone; d₅ is a height of an inner edge of the joint surface; and n is a value of the number of a sub-region in a joint surface region-1;

bending moment equilibrium equations in the failure state are expressed as:

the failure state S-a:

$${M}_{1} = b {\sum }_{i = 1}^{n} {\int }_{{d}_{i}}^{{d}_{i + 1}} {σ}_{c} ( \frac{p}{{x}_{c 1}} \cdot {ε}_{cu} ) ( h - {x}_{c 1} + p ) dp - {f}_{my} {A}_{m} ( h - d ) - {N}_{1} \cdot \frac{h}{2} ;$$

the failure state S-b:

$${M}_{2} = b {\sum }_{i = 1}^{n} {\int }_{{d}_{i}}^{{d}_{i + 1}} {σ}_{c} ( \frac{p}{{x}_{c 2}} \cdot {ε}_{cu} ) ( h - {x}_{c 2} + p ) dp - {f}_{my} {A}_{m} ( h - d ) - {N}_{2} \cdot \frac{h}{2} ;$$

the failure state S-c:

$${M}_{3} = b {\sum }_{i = 1}^{n} {\int }_{{d}_{i}}^{{d}_{i + 1}} {σ}_{c} ( \frac{p}{{x}_{c 3}} \cdot {ε}_{cu} ) ( h - {x}_{c 3} + p ) dp - {σ}_{m} {A}_{m} ( h - d ) - {N}_{3} \cdot \frac{h}{2} ;$$

and

the failure state S-d:

$${M}_{4} = b {\sum }_{i = 1}^{n} {\int }_{{d}_{i}}^{{d}_{i + 1}} {σ}_{c} ( \frac{p}{{x}_{c 4}} \cdot {ε}_{cu} ) ( h - {x}_{c 4} + p ) dp - {σ}_{m} {A}_{m} ( h - d ) - {N}_{4} \cdot \frac{h}{2} ;$$

where Mᵢ is an ultimate bending moment corresponding to each failure state; h is a height of the joint surface; and d is a distance from a bolt to an outer edge of the joint surface.

In an embodiment, in the step (S3), if in the failure state S-c or the failure state S-d, the height x_{c} of the compression zone of the joint surface is greater than the distance d from the bolt to the outer edge of the joint surface, cancel a σₘAₘ term in the axial force equilibrium equation, and return to step (S2) with the failure state S-c or the failure state S-d again; and

in step (S4), if in the failure state S-c or in the failure state S-d, the height x_{c} of the compression zone of the joint surface is greater than the distance d from the bolt to the outer edge of the joint surface, cancel the σₘAₘ(h-d) term in the bending moment equilibrium equation.

In an embodiment, in step (S2), an integral calculation term in the axial force equilibrium equation is replaced with an integral approximation formula for approximate solution, and the integral approximation formula is expressed as:

$${\sum }_{i = 1}^{n} {\int }_{{d}_{i}}^{{d}_{i + 1}} {σ}_{c} ( \frac{p}{{x}_{c}} \cdot {ε}_{cu} ) dp \approx \{ \begin{matrix}α {f}_{c} β ( {x}_{c} - {d}_{1} ) , {d}_{1} \leq {x}_{c} \leq {\sum }_{i = 1}^{2} {d}_{i} \\ α {f}_{c} β {d}_{2} , {\sum }_{i = 1}^{2} {d}_{i} \leq {x}_{c} \leq {\sum }_{i = 1}^{3} {d}_{i} \\ α {f}_{c} β ( {x}_{c} - {d}_{1} - {d}_{3} ) , {x}_{c} > {\sum }_{i = 1}^{3} {d}_{i}\end{matrix} ;$$

wherein α, β are equivalence coefficients expressed as:

$${\int }_{0}^{{x}_{c}} {σ}_{c} ( \frac{p}{{x}_{c}} \cdot {ε}_{cu} ) dp = α {f}_{c} β {x}_{c} ; and$$

$${\int }_{0}^{{x}_{c}} {σ}_{c} ( \frac{p}{{x}_{c}} \cdot {ε}_{cu} ) ( h - {x}_{c} + p ) dp = α {f}_{c} β {x}_{c} ( h - \frac{β {x}_{c}}{2} ) ;$$

wherein f_{c} is a design value of a concrete axial compressive strength.

In an embodiment, in step (S4), an integral approximation formula is used to replace the integral calculation term in the bending moment equilibrium equation for approximate solution, and the integral approximation formula is expressed as:

$${\sum }_{i = 1}^{n} {\int }_{{d}_{i}}^{{d}_{i + 1}} {σ}_{c} ( \frac{p}{{x}_{c}} \cdot {ε}_{cu} ) ( h - {x}_{c} + p ) dp \approx \{ \begin{matrix}α {f}_{c} β ( {x}_{c} - {d}_{1} ) ( h - \frac{β {x}_{c}}{2} - \frac{β {d}_{1}}{2} ) , {d}_{1} \leq {x}_{c} \leq {\sum }_{i = 1}^{2} {d}_{i} \\ α {f}_{c} β {d}_{2} ( h - β {d}_{1} - \frac{β {d}_{2}}{2} ) , {\sum }_{i = 1}^{2} {d}_{i} \leq {x}_{c} \leq {\sum }_{i = 1}^{3} {d}_{i} \\ α {f}_{c} β {d}_{2} ( h - β {d}_{1} - \frac{β {d}_{2}}{2} ) + \\ \frac{1}{2} α {f}_{c} β ( {x}_{c} - {\sum }_{i = 1}^{3} {d}_{i} ) ( 2 h - β {x}_{c} - {\sum }_{i = 1}^{3} β {d}_{i} ) , {x}_{c} > {\sum }_{i = 1}^{3} {d}_{i}\end{matrix} ;$$

wherein f_{c} is a design value of a concrete axial compressive strength.

In an embodiment, the range requirement of x c for each failure state is expressed as:

the failure state S-a: x_{cb2}<x_{c1}≤x_{cb1};

the failure state S-b: x_{c2}≤x_{cb1}and x_{c2}≤x_{cb2};

the failure state S-c: x_{cb1}<x_{c3}≤x_{cb2};and

the failure state S-d: x_{c4}>x_{cb1} and x_{c4}>x_{cb2}.

In a second aspect, this application further provides a computer-readable storage medium, comprising:

one or more instructions; the one or more instructions are stored on the computer-readable storage medium;

the one or more instructions is configured to be loaded by a processor to implement the method.

Compared to the prior art, this application has the following beneficial effects. 1. In this application, based on the actual collected basic parameters of the joint surface to be calculated, the flexural capacity of the steel plate-reinforced joints is obtained in the theoretical way without modeling, to overcome the inefficiency of the numerical simulation in determining the flexural capacity of the steel plate-reinforced joints. The method in this application can quickly determine the flexural capacity of the steel plate-reinforced joints and has reference significance to the shield tunnel steel plate reinforcement.

2. The method in this application considers the concave and convex characteristics of the joint surface, and through the trial calculation of the axial force equilibrium equations of multiple failure states, it can quickly determine the failure state, and obtain the ultimate bending moment of the joint surface, which ensures the accuracy and improves the computational efficiency at the same time.

### BRIEF DESCRIPTION OF THE DRAWINGS

FIG. 1 is a schematic diagram of a structure of a joint surface according to one embodiment of the present disclosure;

FIG. 2 is a stress distribution diagram of the joint surface when a steel plate is reinforced;

FIG. 3 is a stress distribution diagram of the joint surface in case of the section failure; and

FIG. 4 is a flow chart of calculating bearing capacity according to one embodiment of the present disclosure.

### DETAILED DESCRIPTION OF EMBODIMENTS

The present disclosure will be described in detail below in combination with the accompanying drawings and embodiments. This embodiment can be implemented based on the technical solutions of the present disclosure, and the detailed implementation ways and specific operation process are described, which are not intended to limit the disclosure.

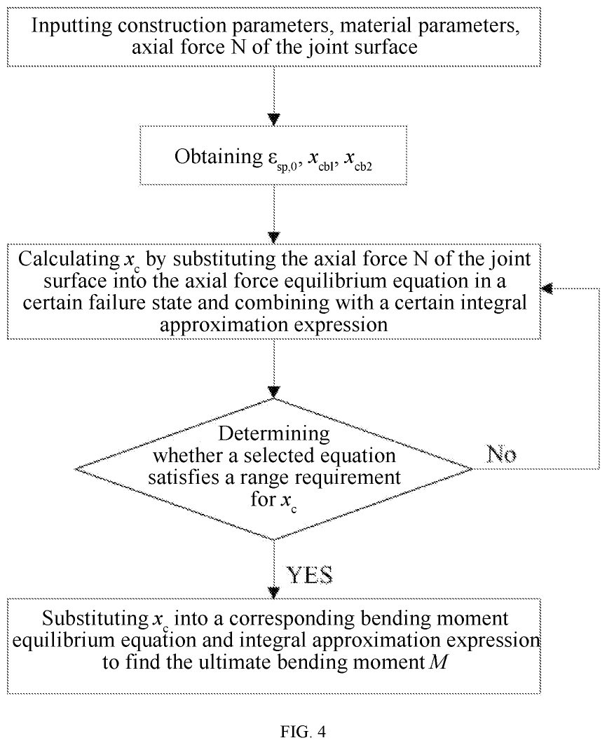

As shown in FIG. 4, this disclosure provides a method for calculating flexural capacity of a steel plate-reinforced joint in shield tunnel includes the following steps: (S1) obtaining a construction parameter, a material parameter, and a mechanical parameter of a joint surface; and calculating a virtual strain ε_{sp,0} at an inner edge of the joint surface when a steel plate is reinforced, a height x_{cb1} of a critical compression zone for bolt yielding in case of section failure, and a height x_{cb2} of a critical compression zone for steel plate yielding; (S2) based on dates obtained in step (S1), assuming that the joint surface is in a certain failure state, and based on an axial force equilibrium equation in the certain failure state, calculating a height x_{c} of a compression zone of a joint surface of the steel plate-reinforced joint; (S3) determining whether the height x_{c} satisfies a range requirement for the height x_{c} in the certain failure state: if so, executing step (S4); and if no, replacing a new failure state; and skipping to step (S2) until traversing all failure states; and (S4) substituting the height x_{c} into a bending moment equilibrium equation for the current failure state; and calculating an ultimate bending moment.

In order to more conveniently utilize the above method, the following assumptions are made prior to the implementation of the above method. A bond performance between the steel plate and the concrete is good. The problem of slip and failure of the bonding surface is not considered. The effect of the thickness of the steel plate is not considered. The deformation of the joint surface meets the assumption of a plane section assumption. The effect of the bolt pre-tightening force on the bending bearing capacity of the joint is not considered. The concrete reaches the ultimate compressive strain as a sign of cross-section failure. The tensile performance of the bolts and the steel plate is considered only. The deformation generated by the joint before reinforcement is moderate, that is, the core and outer edge concrete jointly bears pressure.

The above methods are described in detail as follows.

I. Obtaining basic parameters of the joint surface

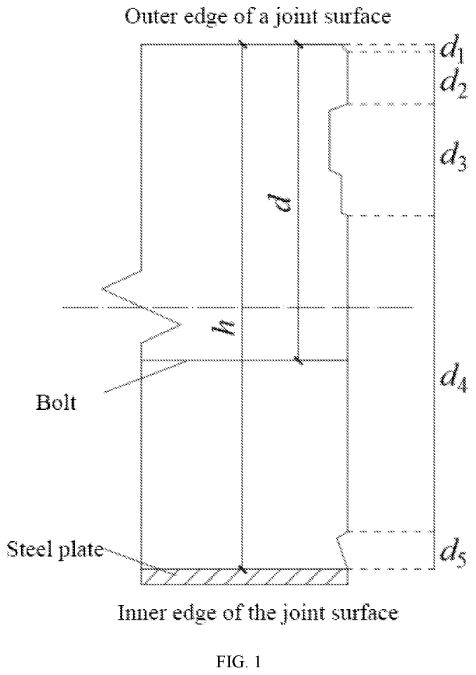

The structure of the joint surface is shown in FIG. 1. The basic parameters include construction parameters, material parameters and mechanical parameters of the joint surface. The structural parameters include: a distance d from a bolt to an outer edge of the joint surface, a height h of the joint surface, a width b of the joint surface, a height d₁ of the outer edge of the joint surface, a height d₂ of an outer edge compression zone, a height d₃ of a waterproof zone, a height d₄ of a core compression zone, a height d 5 of an inner edge of the joint surface, a bolt cross-sectional area Aₘ, and a steel plate cross-sectional area Aₛₚ.

The material parameter includes a design value f c of a concrete axial compressive strength, a concrete yield strain ε_{c0}, a concrete ultimate compressive strain ε_{cu}, a bolt yield strain ε_{my}, a steel plate yield strain ε_{spy}, a bolt yield stress f_{my}, a steel plate yield stress f_{spy}, a bolt elasticity modulus Eₘ, and a steel plate elasticity modulus Eₛₚ.

The mechanical parameters of the joint surface include an axial force N₀ and a bending moment M₀ of the joint surface when the steel plate is reinforced. The above data can be based on engineering design data and field measurement data.

The joint involves concrete, steel reinforcement and steel plate and three kinds of materials. The concrete adopts parabolic and linear combination constitutive relationship, expressed as the formula (1). The bolt adopts bilinear constitutive relationship, expressed as in the formula (2). The steel plate adopts bilinear constitutive relationship, expressed as in the formula (3).

$${σ}_{c} = \{ \begin{matrix}{f}_{c} [ 1 - {( 1 - \frac{{ε}_{c}}{{ε}_{c 0}} )}^{2} ] , {ε}_{c} \leq {ε}_{c 0} \\ {f}_{c} [ 1 - 0.15 ( \frac{{ε}_{c} - {ε}_{c 0}}{{ε}_{cu} - {ε}_{c 0}} ) ] , {ε}_{c 0} < {ε}_{c} \leq {ε}_{cu}\end{matrix} ; \qquad ( 1 )$$

$${σ}_{m} = \{ \begin{matrix}{f}_{my} \cdot {ε}_{m} / {ε}_{my} , 0 \leq {ε}_{m} \leq {ε}_{my} \\ {f}_{my} , {ε}_{my} < {ε}_{m}\end{matrix} ; and \qquad ( 2 )$$

$${σ}_{sp} = \{ \begin{matrix}{f}_{spy} \cdot {ε}_{sp} / {ε}_{spy} , 0 \leq {ε}_{sp} \leq {ε}_{spy} \\ {f}_{spy} , {ε}_{spy} < {ε}_{sp}\end{matrix} . \qquad ( 3 )$$

In the formulas above, σ_{c} is the concrete stress; f_{c} is the design value of the concrete axial compressive strength; ε_{c} is the concrete strain; ε_{c0} is the concrete yield strain, which can be taken as 0.002; ε_{cu} is the concrete ultimate compressive strain, which can be taken as 0.0033; σₘ is the bolt stress; σₛₚ is the steel plate stress; ε_{cm} is the bolt strain; εₛₚ is the steel plate strain; ε_{my} is the bolt yield strain; ε_{spy} is the steel plate yield strain; f_{my} is the bolt yield stress; and f_{spy} is the steel plate yield stress.

II. Determining the virtual strain ε_{sp,0} at the inner edge of the joint surface when the steel plate is reinforced.

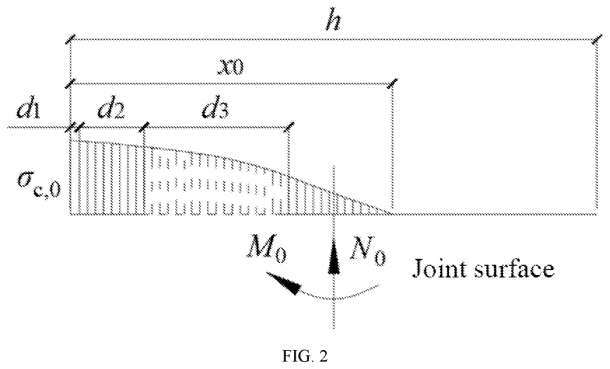

To ensure the reinforcing effect of the joint, the open range of the joint surface before reinforcement should not be too large, the enhancement of the bolt tension on contact surface stress can be ignored, and it is assumed that the concrete constitutive curve is only in the parabolic section. The stress distribution on the joint surface when the steel plate is reinforced is shown in FIG. 2. N₀ is the axial force of the joint surface; M₀ is the bending moment of the joint surface; ε_{c,0} is the concrete yield strain at the outer edge of the joint surface; σ_{c,0} is the concrete compressive stress at the outer edge of the joint surface; and xo is the height of the compression zone of the joint surface. The axial force equilibrium equation is expressed as the formula (4), the bolt stress during reinforcement is expressed as the formula (5), and the bending moment equilibrium equation is expressed as the formula (6). The formulas (4), (5) and (6) are combined to obtain x₀ and ε_{c,0}. x₀ and ε_{c,0} are substituted into the formula (7) to obtain ε_{sp,0}.

$${N}_{0} = b {\int }_{0}^{{x}_{0} - {d}_{1} - {d}_{2} - {d}_{3}} {σ}_{c} ( \frac{p}{{x}_{0}} \cdot {ε}_{c , 0} ) dp + b {\int }_{{x}_{0} - {d}_{1} - {d}_{2}}^{{x}_{0} - {d}_{1}} b {σ}_{c} ( \frac{p}{{x}_{0}} \cdot {ε}_{c , 0} ) dp - {σ}_{m , 0} {A}_{m} ; \qquad ( 4 )$$

$${σ}_{m , 0} = \frac{{ε}_{c , 0} ( d - {x}_{0} ) {E}_{m}}{{x}_{0}} ; \qquad ( 5 )$$

$${M}_{0} = b {\int }_{0}^{{x}_{0} - {d}_{1} - {d}_{2} - {d}_{3}} {σ}_{c} ( \frac{p}{{x}_{0}} \cdot {ε}_{c , 0} ) ( h - {x}_{0} + p ) dp + b {\int }_{{x}_{0} - {d}_{1} - {d}_{2}}^{{x}_{0} - {d}_{1}} {σ}_{c} ( \frac{p}{{x}_{0}} \cdot {ε}_{c , 0} ) ( h - {x}_{0} + p ) dp - {σ}_{m , 0} {A}_{m} ( h - d ) - {N}_{0} \cdot \frac{h}{2} ; and \qquad ( 6 )$$

$${ε}_{sp , 0} = \frac{{ε}_{c , 0} h}{{x}_{0}} - {ε}_{c , 0} . \qquad ( 7 )$$

In above formulas, pis the integral variable; b is the width of the joint surface; and dᵢ and dᵢ₊₁ are the dimensions of each division area of the joint surface.

III. Determining the height x_{cb} of the critical compression zone at the joint surface

x_{cbi1} is the height of the critical compression zone for bolt yielding in case of section failure, expressed as the formula (8); and x_{cb2} is the height of the critical compression zone for steel plate yielding, expressed as the formula (9).

$${x}_{cb 1} = \frac{{ε}_{cu} d}{{ε}_{cu} + {f}_{my} / {E}_{m}} ; and \qquad ( 8 )$$

$${x}_{cb 2} = \frac{{ε}_{cu} h}{{ε}_{cu} + {ε}_{sp , 0} + {f}_{spy} / {E}_{sp}} . \qquad ( 9 )$$

When the compression zone height of the joint surface in case of the joint failure is less than x_{cb1}, the bolt will yield, and otherwise, the bolt will not yield. When the compression zone height of the joint surface in case of the joint failure is less than x_{cb2}, the steel plate will yield, and otherwise, the steel plate will not yield.

IV. Determining the failure state of the joint surface

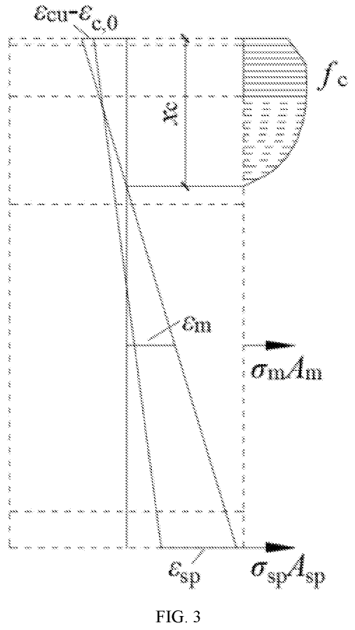

The stress distribution of the joint surface in case of the section fails is shown in FIG. 3. According to whether the bolt or the steel plate yields in case of the section failure, the failure state of the steel plate-reinforced joint is categorized into four: the failure state S-a, the bolt yields and the steel plate does not yield; the failure state S-b, both the bolt and the steel plate yield; the failure state S-c, the bolt does not yield and the steel plate yields; and the failure state S-d, both the bolt and the steel plate do not yield.

The strain and stress distributions at the failure of the joint surfaces are shown in FIG. 3. For the failure state S-a, the height x_{c1} of the compression zone needs to satisfy X_{cb2}<X_{c1}≤X_{cb1}; for the failure state S-b, the height x_{c2} of the compression zone needs to satisfy x_{c2≤}x_{cb1} and x_{c2}≤x_{cb2}; for the failure state S-c, the height x_{c3} of the compression zone needs to satisfy x_{cb1}<x_{c3}≤x_{cb2}; and for the failure state S-d, the height x_{c4} of compression zone needs to satisfy x_{c4}>x_{cb1} and x_{c4}>x_{cb2}.

V. Calculation formulas for the height of compression zone x_{c} and ultimate bending moment M for different failure states of joint surface.

1. In case of the failure state S-a, the axial force equilibrium equation is expressed as formula (10), and the bending moment equilibrium equation is expressed as formula (11). Under the premise that Ni is known, xci and Mi can be obtained by the formulas (10) to (12).

$${N}_{1} = b {\sum }_{i = 1}^{n} {\int }_{{d}_{i}}^{{d}_{i + 1}} {σ}_{c} ( \frac{p}{{x}_{c}} \cdot {ε}_{cu} ) dp - {f}_{my} {A}_{m} - {σ}_{sp} {A}_{sp} \qquad ( 10 )$$

$${M}_{1} = b {\sum }_{i = 1}^{n} {\int }_{{d}_{i}}^{{d}_{i + 1}} {σ}_{c} ( \frac{p}{{x}_{c 1}} \cdot {ε}_{cu} ) ( h - {x}_{c 1} + p ) dp - {f}_{my} {A}_{m} ( h - d ) - {N}_{1} \cdot \frac{h}{2} ; \\ and \qquad ( 11 )$$

$${σ}_{sp} = {ε}_{sp} {E}_{sp} = ( {ε}_{cu} h / {x}_{c 1} - {ε}_{cu} - {ε}_{sp , 0} ) {E}_{sp} \qquad ( 12 )$$

where Ni is the axial force on the joint; Aₘ is the cross-sectional area of the bolt; Aₛₚ is the cross-sectional area of the steel plate; and n has no physical significance, and numerically, n is a value of the number of a sub-region in a joint surface region-1.

2. In case of the failure state S-b when the axial force equilibrium equation is expressed as the formula (13), and the bending moment equilibrium equation is expressed as the formula (14). Under the premise that N₂ is known, x₂ and M₂ can be obtained by the formulas (13) to (14).

$${N}_{2} = b {\sum }_{i = 1}^{n} {\int }_{{d}_{i}}^{{d}_{i + 1}} {σ}_{c} ( \frac{p}{{x}_{c}} \cdot {ε}_{cu} ) dp - {f}_{my} {A}_{m} - {f}_{spy} {A}_{sp} ; and \qquad ( 13 )$$

$${M}_{2} = b {\sum }_{i = 1}^{n} {\int }_{{d}_{i}}^{{d}_{i + 1}} {σ}_{c} ( \frac{p}{{x}_{c 2}} \cdot {ε}_{cu} ) ( h - {x}_{c 2} + p ) dp - {f}_{my} {A}_{m} ( h - d ) - {N}_{2} \cdot \frac{h}{2} . \qquad ( 14 )$$

3. In case of the failure state S-c, the axial force equilibrium equation is expressed as the formula (15), and the bending moment equilibrium equation is expressed as the formula (16). Under the premise that N₃ is known, x_{c3} and M₃ can be obtained by the formulas (15) to (17).

$${N}_{3} = b {\sum }_{i = 1}^{n} {\int }_{{d}_{i}}^{{d}_{i + 1}} {σ}_{c} ( \frac{p}{{x}_{c}} \cdot {ε}_{cu} ) dp - {σ}_{m} {A}_{m} - {f}_{spy} {A}_{sp} ; \qquad ( 15 )$$

$${M}_{3} = b {\sum }_{i = 1}^{n} {\int }_{{d}_{i}}^{{d}_{i + 1}} {σ}_{c} ( \frac{p}{{x}_{c 3}} \cdot {ε}_{cu} ) ( h - {x}_{c 3} + p ) dp - {σ}_{m} {A}_{m} ( h - d ) - {N}_{3} \cdot \frac{h}{2} ; \\ and \qquad ( 16 )$$

$${σ}_{m} = {ε}_{m} {E}_{m} = ( \frac{{ε}_{cu} d}{{x}_{c 3}} - {ε}_{cu} ) {E}_{m} . \qquad ( 17 )$$

4. In case of the failure state S-d, the axial force equilibrium equation is expressed as the formula (18), and the bending moment equilibrium equation is expressed as the formula (19). Under the premise that N₄ is known, x_{c4} and M₄ can be obtained by the formulas (18) to (19).

$${N}_{4} = b {\sum }_{i = 1}^{n} {\int }_{{d}_{i}}^{{d}_{i + 1}} {σ}_{c} ( \frac{p}{{x}_{c}} \cdot {ε}_{cu} ) dp - {σ}_{m} {A}_{m} - {σ}_{sp} {A}_{sp} ; and \qquad ( 18 )$$

$${M}_{4} = b {\sum }_{i = 1}^{n} {\int }_{{d}_{i}}^{{d}_{i + 1}} {σ}_{c} ( \frac{p}{{x}_{c 4}} \cdot {ε}_{cu} ) ( h - {x}_{c 1} + p ) dp - {σ}_{m} {A}_{m} ( h - d ) - {N}_{4} \cdot \frac{h}{2} . \qquad ( 19 )$$

The above calculation method does not consider the compressive properties of the bolt and the steel plate. If the height x_{c} of the compression zone of the joint surface is greater than the distance d from the bolt to the outer edge of the joint surface, it is necessary to cancel the σₘAₘ term from formulas (15) and (18), and the σₘAₘ(h-d) term from formulas (16) and (19).

The above method adopts a trial calculation method, substitutes the obtained parameters one by one into the axial force equilibrium equation corresponding to each failure state, and combines with the integral approximation formula of the axial force equilibrium equation to obtain the height x_{c} of the compression zone of the joint surface, and judges whether the height x_{c} meets the range requirement of the selected axial force equilibrium equation and integral approximation formula for x_{c}. If the height x_{c} meets the requirement, it means that the selected failure state is correct. After clarifying the failure state of the joint surface, the ultimate bending moment is calculated by substituting into the bending moment equilibrium equation corresponding to the failure state and combining with the integral approximation formula of the bending moment equilibrium equation.

VI. Approximate solution method of the calculation formula

Since the above formulas involve complex integral calculations, the rapid solution of the ultimate bending moment of the joint become difficult. To simplify the formulas, in this embodiment, an equivalence method can be used to convert the stress distribution form of the concrete on the joint surface to a rectangular distribution. To ensure that the axial force and bending moment at the joint surface remain unchanged after the conversion, the formulas (20) and (21) need to be satisfied.

$$\text{?} {σ}_{c} ( \frac{p}{{x}_{c}} \cdot {ε}_{cu} ) dp = α {f}_{c} β {x}_{c} ; and$$

$$\text{?} {σ}_{c} ( \frac{p}{{x}_{c}} \cdot {ε}_{cu} ) ( h - {x}_{c} + p ) dp = α {f}_{c} β {x}_{c} ( h - \frac{β {x}_{c}}{2} ) .$$

$$\text{?} \text{indicates text missing or illegible when filed}$$

In the formula, α, β is the equivalence coefficient.

VII. Determining the approximate expression of the integral part involved in the formulas (10) to (19), as shown in Table 1.

TABLE 1
Approximate expression for an integral part of the computational model

| | | |
|---|---|---|
| Height of range of concrete compression strain distribution | Approximate equivalent representation of $\text{?} \text{?} σ \text{?} ( \frac{p}{x \text{?}} \cdot ε \text{?} ) d p$ | Approximate equivalent representation of $\text{?} \text{?} σ \text{?} ( \frac{p}{x \text{?}} \cdot ε \text{?} ) ( h - x \text{?} + p ) d p$ |
| ${d}_{1} \leq x \text{?} \leq {\sum }_{i = 1}^{2} {d}_{1}$ | αf_{c}β(x_{c} − d₁) | $α {f}_{c} β ( x \text{?} - {d}_{1} ) ( h - \frac{β x \text{?}}{2} - \frac{β {d}_{1}}{2} )$ |
| ${\sum }_{i = 1}^{2} {d}_{1} \leq x \text{?} \leq {\sum }_{i = 1}^{3} {d}_{1}$ | αf_{c}βd₂ | $α f \text{?} β {d}_{2} ( h - β {d}_{1} - \frac{β {d}_{2}}{2} )$ |
| ${x}_{c} > {\sum }_{i = 1}^{3} {d}_{1}$ | αf_{c}β(x_{c} − d₁ − d₃) | $α f \text{?} β {d}_{2} ( h - β {d}_{1} - \frac{β {d}_{2}}{2} ) + \frac{1}{2} α f \text{?} β ( x \text{?} - \text{?} {d}_{1} ) ( 2 h - β x \text{?} - {\sum }_{i = 1}^{3} β {d}_{1} )$ |

$\text{?} \text{indicates text missing or illegible when filed}$

The method described above may be stored in a computer-readable storage medium when the method is realized in the form of a software functional unit and sold or used as a separate product. Based on this understanding, the technical solution of the present disclosure is essentially or contributes to the prior art or parts of the technical solution may be embodied in the form of a software product. The software product is stored in a storage medium and comprises several instructions configured to cause a computer device (which may be a personal computer, a server, or a network device, etc.) to perform all or part of the steps of the method described in the various embodiments of the present disclosure. The aforementioned storage medium includes a USB flash drive, a removable hard disk, a read-only memory (ROM), a random access memory

(RAM), a magnetic disk, or a CD-ROM, and other media that can store program code.

### EMBODIMENT

The above method is illustrated with specific engineering cases.

1. According to the engineering design information, the obtained construction and material parameters of the joint surface were as follows.

h=350 mm; d=200 mm; d₁=5 mm; d₂=35 mm; d₃=74 mm; d₄=211 mm; b=1500 mm; f_{c}=25.3 MPa; f_{spy}=200 MPa; f_{my}=400 MPa; Eₛₚ=210 GPa; E_{c}=35.5 GPa; Eₘ=206 GPa; N=1000 kN; M₀=1500 kN·m; Aₘ=1413.5 mm²; and Aₛₚ=3000 mm².

2. The above parameters were substituted into the corresponding formula to obtain the virtual strain ε_{sp,0}=0.0015.

3. The height x_{cb1}=125.9 mm of the critical compression zone for bolt yielding and the height x_{cb2}=200.8 mm of the critical compression zone for steel plate yielding when the section failed were obtained.

4. N=1000 kN was substituted into the axial force equilibrium equation corresponding to each failure state of the joint surface to perform trial calculation, to finally determine that the x_{c} was 145.7 mm, the failure state of the joint surface was S-c showing that the steel plate yielded but the bolt did not yield when the section failed, that the bolt stress was 358.1 MPa.

5. x_{c}=145.7 mm was substituted into the bending moment equilibrium equation corresponding to the failure state S-c, to obtain the ultimate bending moment M of the joint surface was 334.2 kN·m.

The above results were closer to the results calculated using numerical simulation, indicating that the above method could ensure a certain calculation accuracy and improve calculation efficiency.

Described above are merely preferred embodiments of the disclosure, which are not intended to limit the disclosure. It should be understood that any modifications and replacements made by those skilled in the art without departing from the spirit of the disclosure should fall within the scope of the disclosure defined by the appended claims.

What is claimed is:

1. A method for calculating flexural capacity of a steel plate-reinforced joint in shield tunnel, comprising:
(S1) obtaining a construction parameter, a material parameter, and a mechanical parameter of a joint surface; and calculating a virtual strain ε_{sp,0} at an inner edge of the joint surface when a steel plate is reinforced, a height x_{cb1} of a critical compression zone for bolt yielding in case of section failure, and a height x_{cb2} of a critical compression zone for steel plate yielding in case of section failure;
(S2) based on step (S1), assuming that the joint surface is in a certain failure state, and based on an axial force equilibrium equation in the certain failure state, calculating a height x_{c} of a compression zone of the joint surface of the steel plate-reinforced joint;
(S3) determining whether the height x c satisfies a range requirement for the height x_{c} in the certain failure state:
if so, executing step (S4); and
if no, replacing a new failure state; and skipping to step (S2) until traversing all failure states; and
(S4) substituting the height x_{c} into a bending moment equilibrium equation for a current failure state; and calculating an ultimate bending moment.

2. The method of claim 1, wherein the construction parameter comprises a distance from a bolt to an outer edge of the joint surface, a height of the joint surface, a width of the joint surface, a height of the outer edge of the joint surface, a height of an outer edge compression zone, a height of a waterproof zone, a height of a core compression zone, a height of an inner edge of the joint surface, a bolt cross-sectional area, and a steel plate cross-sectional area;
the material parameter comprises a design value of a concrete axial compressive strength, a concrete yield strain, a concrete ultimate compressive strain, a bolt yield strain, a steel plate yield strain, a bolt yield stress, a steel plate yield stress, a bolt 30 elasticity modulus, and a steel plate elasticity modulus; and
the mechanical parameter comprises an axial force and a bending moment of the joint surface when the steel plate is reinforced.

3. The method of claim 1, wherein a formula for calculating the virtual strain ε_{sp,0} at the inner edge of the joint surface when the steel plate is reinforced is expressed as:
$${ε}_{sp , 0} = \frac{\text{?} h}{{x}_{0}} - \text{?} ;$$
$$\text{?} \text{indicates text missing or illegible when filed}$$
wherein ε_{c,0} is a concrete compressive strain at an outer edge of the joint surface when the steel plate is reinforced; xo is a height of a compression zone of the joint surface when the steel plate is reinforced; and h is a height of the joint surface;
formulas for calculating ε_{c,0} and x₀ are expressed as:
$$\text{?} ( \text{?} ) = \text{?} [ 1 - {( 1 - \frac{\text{?}}{\text{?}} )}^{2} ] ;$$
$${N}_{0} = b \text{?} ( \frac{p}{{x}_{0}} \cdot \text{?} ) dp + b \text{?} b \text{?} ( \frac{p}{{x}_{0}} \cdot \text{?} ) dp - {σ}_{m , 0} {A}_{m} ;$$
$${σ}_{m , 0} = \frac{\text{?} ( d - {x}_{0} ) {E}_{m}}{{x}_{0}} ; and$$
$${M}_{0} = b \text{?} ( \frac{p}{{x}_{0}} \cdot \text{?} ) ( h - {x}_{0} + p ) dp + b \text{?} ( \frac{p}{{x}_{0}} \cdot \text{?} ) ( h - {x}_{0} + p ) dp - \text{?} ( h - d ) - \text{?} \cdot \frac{h}{2} ;$$
$$\text{?} \text{indicates text missing or illegible when filed}$$
where σ_{c} is a concrete stress; ε_{c} is a concrete strain; f_{c} is a design value of a concrete axial compressive strength; ε_{c0} is a concrete yield strain; b is a width of the joint surface; d₁ is an outer edge of the joint surface; d₂ is a height of an outer edge compression zone; d₃ is a height of a waterproof zone; d₄ is a height of a core compression zone; d₅ is a height of an inner edge of the joint surface; p is an integral variable; N₀ is an axial force of the joint surface when the steel plate is reinforced; M₀ is a bending moment of the joint surface when the steel plate is reinforced; σ_{m,0} is a bolt stress when the steel plate is reinforced; Aₘ is a bolt cross-sectional area; and Eₘ is a bolt elasticity modulus.

4. The method of claim 1, wherein the height x_{cb1} of the critical compression zone of the bolt yielding and the height x_{cb2} of the critical compression zones of the steel plate yielding are obtained according to the following formulas:
$${x}_{cb 1} = \frac{{ε}_{cu} d}{{ε}_{cu} + {f}_{my} / {E}_{m}} ; and$$
$${x}_{cb 2} = \frac{{ε}_{cu} h}{{ε}_{cu} + {ε}_{sp , 0} + {f}_{spy} / {E}_{sp}} ;$$
wherein ε_{cu} is a concrete ultimate compressive strain; f_{my} is a bolt yield stress; Eₘ is a bolt elasticity modulus; d is a distance from a bolt to an outer edge of the joint surface; f_{spy} is a steel plate yield stress; Eₛₚ is a steel plate elasticity modulus; and h is a height of the joint surface.

5. The method of claim 1, wherein the failure state comprises a failure state S-a, a failure state S-b, a failure state S-c, and a failure state S-d; the failure state S-a refers to a state of bolt yielding and steel plate not-yielding; the failure state S-b refers to a state of both bolt and steel plate yielding; the failure state S-c refers to a state of bolt not yielding and steel plate yielding; and the failure state S-d refers to a state of both bolt and steel plate not yielding;
axial force equilibrium equations in the failure state are expressed as:
the failure state S-a:
$${N}_{1} = b {\sum }_{i = 1}^{n} \text{?} {σ}_{c} ( \frac{p}{{x}_{c 1}} \cdot {ε}_{cu} ) dp - {f}_{my} {A}_{m} - {σ}_{sp} {A}_{sp} ;$$
$$\text{?} \text{indicates text missing or illegible when filed}$$
20 the failure state S-b:
$${N}_{2} = b {\sum }_{i = 1}^{n} \text{?} {σ}_{c} ( \frac{p}{{x}_{c 2}} \cdot {ε}_{cu} ) dp - {f}_{my} {A}_{m} - {f}_{spy} {A}_{sp} ;$$
$$\text{?} \text{indicates text missing or illegible when filed}$$
the failure state S-c:
$${N}_{3} = b {\sum }_{i = 1}^{N} \text{?} {σ}_{c} ( \frac{p}{{x}_{c 3}} \cdot {ε}_{cu} ) dp - {σ}_{m} {A}_{m} - {f}_{spy} {A}_{sp} ;$$
$$\text{?} \text{indicates text missing or illegible when filed}$$
and
the failure state S-d:
$${N}_{4} = b {\sum }_{i = 1}^{n} \text{?} {σ}_{c} ( \frac{p}{{x}_{c 4}} \cdot {ε}_{cu} ) dp - {σ}_{m} {A}_{m} - {σ}_{sp} {A}_{sp} ;$$
$$\text{?} \text{indicates text missing or illegible when filed}$$
where σₛₚ is a steel plate stress at section failure; εₛₚ is a steel plate strain at section failure; σₘ is a bolt stress at section failure; b is a width of the joint surface; p is an integral variable; σ_{c} is a concrete stress; Ecu is a concrete ultimate compressive strain; Aₘ is a bolt cross-sectional area; Aₛₚ is a steel plate cross-section area; f_{my} is a bolt yield stress; f_{spy} is a steel plate yield stress; Nᵢ is a section axial force corresponding to each failure state; x_{ci} is a height of a compression zone of the joint surface corresponding to each failure state, i=1 ,2 ,3 ,4; d₁ is a height of an outer edge of the joint surface; d₂ is a height of an outer edge compression zone; d₃ is a height of a waterproof zone; d₄ is a height of a core compression zone; d₅ is a height of an inner edge of the joint surface; and n is a value of the number of a sub-region in a joint surface region-1;
bending moment equilibrium equations in the failure state are expressed as:
the failure state S-a:
$${M}_{1} = b {\sum }_{i = 1}^{n} \text{?} {σ}_{c} ( \frac{p}{{x}_{c 1}} \cdot {ε}_{cu} ) ( h - {x}_{c 1} + p ) dp - {f}_{my} {A}_{m} ( h - d ) - {N}_{1} \cdot \frac{h}{2} ;$$
$$\text{?} \text{indicates text missing or illegible when filed}$$
the failure state S-b:
$${M}_{2} = b {\sum }_{i = 1}^{n} \text{?} {σ}_{c} ( \frac{p}{{x}_{c 2}} \cdot {ε}_{cu} ) ( h - {x}_{c 2} + p ) dp - {f}_{my} {A}_{m} ( h - d ) - {N}_{2} \cdot \frac{h}{2} ;$$
$$\text{?} \text{indicates text missing or illegible when filed}$$
the failure state S-c:
$${M}_{3} = b {\sum }_{i = 1}^{n} \text{?} {σ}_{c} ( \frac{p}{{x}_{c 3}} \cdot {ε}_{cu} ) ( h - {x}_{c 3} + p ) dp - {σ}_{m} {A}_{m} ( h - d ) - {N}_{3} \cdot \frac{h}{2} ;$$
$$\text{?} \text{indicates text missing or illegible when filed}$$
and
the failure state S-d:
$${M}_{4} = b {\sum }_{i = 1}^{n} \text{?} {σ}_{c} ( \frac{p}{{x}_{c 4}} \cdot {ε}_{cu} ) ( h - {x}_{c 4} + p ) dp - {σ}_{m} {A}_{m} ( h - d ) - {N}_{4} \cdot \frac{h}{2} ;$$
$$\text{?} \text{indicates text missing or illegible when filed}$$
where Mᵢ is an ultimate bending moment corresponding to each failure state; h is a height of the joint surface; and d is a distance from a bolt to an outer edge of the joint surface.

6. The method of claim 5, wherein in the step (S3), if in the failure state S-c or the failure state S-d, the height x_{c} of the compression zone of the joint surface is greater than the distance d from the bolt to the outer edge of the joint surface, cancel a σₘAₘ term in the axial force equilibrium equation, and return to step (S2) with the failure state S-c or the failure state S-d again; and
in step (S4), if in the failure state S-c or in the failure state S-d, the height x_{c} of the compression zone of the joint surface is greater than the distance d from the bolt to the outer edge of the joint surface, cancel the σₘAₘ(h-d) term in the bending moment equilibrium equation.

7. The method of claim 5, wherein in step (S2), an integral calculation term in the axial force equilibrium equation is replaced with an integral approximation formula for approximate solution, and the integral approximation formula is expressed as:
$${\sum }_{i = 1}^{n} \text{?} {σ}_{c} ( \frac{p}{{x}_{c}} \cdot {ε}_{cu} ) dp \approx \{ \begin{matrix}α {f}_{c} β ( {x}_{c} - {d}_{1} ) , {d}_{1} \leq {x}_{c} \leq {\sum }_{i = 1}^{2} \text{?} \\ α {f}_{c} β {d}_{2} , {\sum }_{i = 1}^{2} \text{?} \leq {x}_{c} \leq {\sum }_{i = 1}^{3} \text{?} \\ α {f}_{c} β ( {x}_{c} - \text{?} - {d}_{3} ) , {x}_{c} > {\sum }_{i = 1}^{3} \text{?}\end{matrix} ;$$
$$\text{?} \text{indicates text missing or illegible when filed}$$
wherein α, β are equivalence coefficients expressed as:
$$\text{?} {σ}_{c} ( \frac{p}{{x}_{c}} \cdot \text{?} ) dp = α {f}_{c} β {x}_{c} ; and$$
$$\text{?} {σ}_{c} ( \frac{p}{{x}_{c}} \cdot \text{?} ) ( h - {x}_{c} + p ) dp = α {f}_{c} β {x}_{c} ( h - \frac{β {x}_{c}}{2} ) ;$$
$$\text{?} \text{indicates text missing or illegible when filed}$$
wherein f_{c} is a design value of a concrete axial compressive strength.

8. The method of claim 5, wherein in step (S4), an integral approximation formula is used to replace the integral calculation term in the bending moment equilibrium equation for approximate solution, and the integral approximation formula is expressed as:
$${\sum }_{i = 1}^{n} \text{?} {σ}_{c} ( \frac{p}{{x}_{c}} \cdot {ε}_{cu} ) ( h - \text{?} + p ) dp \approx \{ \begin{matrix}α {f}_{c} β ( {x}_{c} - \text{?} ) ( h - \frac{β {x}_{c}}{2} - \frac{β \text{?}}{2} ) , \text{?} \leq \text{?} \leq {\sum }_{i = 1}^{2} \text{?} \\ α {f}_{c} β {d}_{2} ( h - β \text{?} - \frac{β {d}_{2}}{2} ) , {\sum }_{i = 1}^{2} \text{?} \leq \text{?} \leq {\sum }_{i = 1}^{3} \text{?} \\ α {f}_{c} β {d}_{2} ( h - β \text{?} - \frac{β {d}_{2}}{2} ) \\ + \frac{1}{2} α {f}_{c} β ( \text{?} - {\sum }_{i = 1}^{3} \text{?} ) ( 2 h - β {x}_{c} - {\sum }_{i = 1}^{3} β \text{?} ) , \text{?} > {\sum }_{i = 1}^{3} \text{?}\end{matrix} ;$$
$$\text{?} \text{indicates text missing or illegible when filed}$$
wherein f_{c} is a design value of a concrete axial compressive strength.

9. The method of claim 5, wherein the range requirement of x_{c} for each failure state is expressed as:
the failure state S-a: x_{cb2}<x_{c1}≤x_{cb1};
the failure state S-b: x_{c2}≤x_{cb1}and x_{c2}≤x_{cb2};
the failure state S-c: x_{cb1}<x_{c3}≤x_{cb2}; and
the failure state S-d: x_{c4}>x_{cb1} and x_{c4}>x_{cb2}.

10. A computer-readable storage medium, comprising:
one or more instructions;
the one or more instructions are stored on the computer-readable storage medium;
the one or more instructions is configured to be loaded by a processor to implement the method of claim 1.
